(19) United States
(12) Patent Application Publication
(10) Pub. No.: US 2005/0082911 A1
(43) Pub. Date: Apr. 21, 2005

(54) Slip regulation algorithm for an automotive vehicle using a normal force estimate and a predetermined peak wheel slip value

(75) Inventor: Sohel Anwar, Canton, MI (US)

Correspondence Address: ARTZ & ARTZ, P.C., 28333 TELEGRAPH RD., SUITE 250, SOUTHFIELD, MI, 48034, US

(73) Assignee: Visteon Global Technologies, Inc.

(21) Appl. No.: 10/973,731

(22) Filed: Oct. 26, 2004

Related U.S. Application Data
(63) Continuation-in-part of application No. 10/071,331, filed on Feb. 8, 2002, now abandoned.

(51) Int. Cl. B60T 8/72

(52) U.S. Cl. 303/171

(57) ABSTRACT

A control system (12) for an automotive vehicle includes a wheel speed sensor (18) generating a rotational speed signal and a controller (14) coupled to the wheel speed sensor. The controller determines a vehicle speed, calculates wheel slip based upon the vehicle speed and the rotational speed, estimates a normal force on the wheel, calculates a modified brake torque signal in response to the wheel slip and the normal force, and actuates the wheel brake in response to the modified brake torque signal.

### RELATED APPLICATIONS

The present application is a continuation-in-part of U.S. patent application Ser. No. 10/071,331 filed on Feb. 8, 2002, the disclosure of which is incorporated by reference herein.

### TECHNICAL FIELD

The present invention relates generally to an anti-lock braking system for an automotive vehicle, and more specifically, to a method and apparatus for controlling the slip of the wheel in accordance with a the normalized force on the wheel and a predetermined peak wheel slip value.

### BACKGROUND

Anti-lock braking systems are commonly used in automotive vehicles to prevent the wheels from locking when the vehicle is over-braked. By preventing the wheels from locking the directional stability and steerability of the vehicle may be maintained. Each of the wheels is typically monitored separately and controlled separately. Each wheel has a wheel-speed sensor that monitors the rotational motion of the wheel. If one of the wheels shows signs of locking there is a sharp rise in the peripheral wheel deceleration and in wheel slip. If the wheel slip exceeds a defined value, a brake controller commands a solenoid valve unit to stop or reduce the build up of brake pressure. The brake pressure is subsequently increased to prevent an under-brake situation.

Typically such systems merely monitor the slip rate or the wheel speed in determining whether to apply brake pressure or reduce brake pressure. The amount of reduction or increase in the application of brake pressure is typically a constant or an open loop value. The amount of pressure or torque is not typically taken into consideration. That is, a fixed amount of brake pressure is applied or removed.

It would therefore be desirable to adjust an amount of braking torque or pressure to the vehicle wheels in response to sensed operating conditions of the vehicle rather than merely a fixed amount based upon wheel slip.

### SUMMARY OF THE INVENTION

The present invention uses sensed and estimated vehicle conditions such as peak slip, normal force, and wheel slip to determine a braking torque for each wheel of the vehicle.

In one aspect of the invention, a control system for an automotive vehicle includes a wheel speed sensor generating a rotational speed signal and a controller coupled to the wheel speed sensor. The controller determines a vehicle speed, calculates wheel slip based upon the vehicle speed and the rotational speed, estimates a normal force on the wheel, calculates a modified brake torque signal in response to the wheel slip and the normal force, and actuates the wheel brake in response to the modified brake torque signal.

In a further aspect of the invention, a method of controlling a vehicle having a wheel and wheel brake comprises measuring rotational speed of a wheel, determining a vehicle speed, calculating wheel slip based upon the vehicle speed and the rotational speed, estimating a normal force on the wheel, calculating a modified brake torque signal in response to the wheel slip and the normal force, and actuating the wheel brake in response to the modified brake torque signal.

One advantage of the invention is that an amount of braking torque to be applied for each vehicle is calculated using the varying conditions of the vehicle and thus a more accurate representation of the amount of brake torque to be applied may be determined. Consequently, the response of the anti-lock brake system is more rapid than previously known brake systems.

Other advantages and features of the present invention will become apparent when viewed in light of the detailed description of the preferred embodiment when taken in conjunction with the attached drawings and appended claims.

### BRIEF DESCRIPTION OF THE DRAWINGS

FIG. 1 is a block diagram showing a portion of a microprocessor interconnected to sensors and controlled devices which may be included in a system according to the present invention.

FIG. 2 is a side view of a wheel illustrating the dynamic forces during a braking event.

FIG. 3 is a plot of friction coefficients versus a slip curve for a number of road-tire interfaces.

FIG. 4 is a simplified friction coefficient versus slip curve plot.

FIG. 5 is a logic flow diagram in accordance with the present invention.

### DESCRIPTION OF THE PREFERRED EMBODIMENT

In the following figures the same reference numerals will be used to identify the same components in the various views.

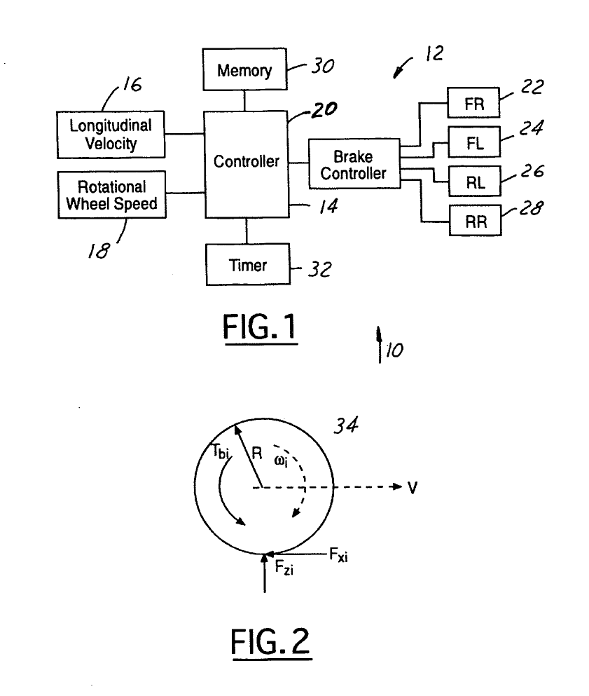

Referring now to FIG. 1, an automotive vehicle 10 having an anti-lock brake control system 12 is illustrated having a controller 14 used for receiving information from a number of sensors that may include a longitudinal velocity estimator 16 and a rotational wheel speed sensor 18. Longitudinal velocity estimator estimates the longitudinal velocity of the vehicle, either directly or indirectly. Other sensors such as lateral acceleration, pitch rate yaw rate or roll rate may also be used but has little effect on the torque calculation as described below. Based on inputs from sensor 16, 18, controller 14 controls a brake controller 20 to provide an amount of brake torque by regulating a plurality of brake actuators including electromagnetic, electromechanical, and electrohydraulic actuators or a combination thereof at a front right brake and wheel assembly 22, a front left brake and wheel assembly 24, a rear left brake and wheel assembly 26, and a right rear brake and wheel assembly 28. Although controller 14 and controller 20 are illustrated as separate components, one single microprocessor may implement the functions of both.

Controller 14 is coupled to a memory 30 and a timer 32. Memory 30 may be used to store various information used in the following calculations such as the vehicle speed and the effective wheel rolling rate. The timer may be used for timing various events such as up timing and down timing as well as the synchronization of the control system described herein.

Longitudinal velocity sensor and rotational wheel speed sensor 18 may be integrally formed. Each wheel has a rotational wheel speed sensor 18 that may be averaged by controller 14 to obtain the longitudinal velocity 16 of the vehicle. Of course, the longitudinal speed of the vehicle may be determined by various other types of sensors such as a transmission sensor. Also, in the averaging scenario, when the vehicle is speeding up or braking around a corner, the lowest or highest wheel speed may not be used because of its error. Various schemes for measuring wheel speed and the speed of the vehicle would be evident to those skilled in the art.

Referring now to FIG. 2, a wheel 34 that generally represents each of the wheels of the vehicle, is illustrated having various forces acting thereon. T_{bi} is the brake torque at the i-th wheel. ωᵢ is the angular speed of i-th wheel, Fₓᵢ is the longitudinal frictional force at the i-th higher contact patch, F_{zi} is the normal force of the i-th wheel, and V is the velocity of the vehicle.

Like most of the ABS control algorithm, the current controller also requires the knowledge of wheel slip. The objective of the controller is to keep the wheel slip at a value that would maximize the tire-road adhesion (or minimize the tire slip). This is unlike previously known systems that oscillate greatly and have greater variations in slip angles. Normalized tire slip is obtained from the following definition:

$${κ}_{i} ( t ) = \frac{V - R {ω}_{i}}{V} \qquad ( 1 )$$

where

R=Effective rolling radius for the tire

ωᵢ=Wheel rotational speed for i-th tire

V=Vehicle longitudinal speed in road coordinate system.

It is necessary to obtain the dynamic equations for the vehicle motion in order to develop the control algorithm. A simplified vehicle model is obtained for a straight line braking event. The vehicle motion in the longitudinal direction on the road plane is described by the following equation.
ΣFₓᵣ=Fₓₛᵤₘᵣ+Fₜₓᵣ−Fₐₓᵣ=M(\dot{V}−V_{y}rᵣ)+mₛ\dot{Z}ₛᵣqᵣ
where

Fₓₛᵤₘᵣ=sum of road forces in the x-direction at the road tire interfaces

Fₜₓᵣ=Terrain forces at the c.g. arising out of road slopes and grades

Fₐₓᵣ=Aerodynamic drag forces on the vehicle

M=Total vehicle mass

\dot{V}=Vehicle longitudinal velocity

V_{y}=Vehicle lateral velocity

rᵣ=Vehicle yaw velocity

mₛ=Sprung mass of the vehicle

\dot{Z}ₛᵣ=Sprung mass velocity in the

qᵣ=Pitch velocity of the sprung mass

The wheel rotational dynamics shown in FIG. 2 are given by the following equation:
ΣM_{y}=T_{bi}−FₓᵢR−FᵣᵣᵢR−T_{di}=−I_{wi}\dot{ω}ᵢ
where

T_{bi}=Brake torque at i-th wheel

ωᵢ=Angular speed of i-th wheel

Fₓᵢ=Longitudinal friction force at i-th tire contact patch

R=Effective wheel rolling radius

Fᵣᵣᵢ=Rolling Resistance at i-th tire contact patch

T_{di}=Drive torque at i-th wheel

I_{wi}=i-th wheel rotational inertia

\dot{ω}ᵢ=Angular acceleration of i-th wheel

For a braking event, the following set of equations of motion is written.
Fₓₛᵤₘᵣ+Fₜₓᵣ−Fₐₓᵣ=M(\dot{V}−V_{y}rᵣ)+mₛ\dot{Z}ₛᵣqᵣ
T_{bi}−FₓᵢR−FᵣᵣᵢR−T_{di}=−I_{wi}\dot{ω}ᵢ (2)

The pitch dynamics of the vehicle in the first equation is assumed to have negligible effect on the wheel braking forces. For the sake of simplicity, the effect of terrain forces arising out of road slopes and grades are also neglected. The drive torque (in a braking situation) is assumed to be insignificant in the second equation. Further simplification is made by assuming that the steer wheel angle is zero resulting in zero lateral motion. Also, the following relationships are defined:
Fₓᵢ=μᵢF_{zi}; Fᵣᵣᵢ=ηF_{zi}
where μᵢ(κ)=Friction Coefficient and η=Rolling Resistance Coefficient.

Since a simple model is desired for the proposed controller development, the effect of aerodynamic drag and rolling resistance on the above equation are neglected. The above assumption is justified based on the fact that the rolling resistance is insignificant compared to the braking force in a braking event. Also, the aerodynamic drag is small for the normal driving speeds. Since controller 14 is a closed loop system, these effects can be compensated through the feedback information. The following equations are obtained:
Fₓₛᵤₘᵣ=−Σμᵢ(κᵢ)F_{zi};

The simplified equations of motion are then given by:
−Σμᵢ(κᵢ)F_{zi}=M\dot{V}
T_{bi}−μᵢ(κᵢ)F_{zi}R=−I_{wi}\dot{ω}ᵢ

Based on the above equations, a model for the controller is obtained as follows:

$$\dot{V} = - \frac{1}{M} {\sum }^{} {μ}_{i} ( {κ}_{i} ) {F}_{zi} \\ {\dot{ω}}_{i} = \frac{1}{{I}_{wi}} ( - {T}_{bi} + {μ}_{i} ( {κ}_{i} ) {F}_{zi} R ) \\ Now , \\ {κ}_{i} ( t ) = \frac{V - R {ω}_{i}}{V} = 1 - \frac{R {ω}_{i}}{V} \qquad ( 3 )$$

Then by differentiation and then substitution,

$${\dot{κ}}_{i} = \frac{R}{{I}_{w i}} \frac{1}{V} {T}_{bi} - \frac{{R}^{2}}{{I}_{wi}} \frac{1}{V} μ ( {κ}_{i} ) {F}_{zi} - \frac{R {ω}_{i}}{{V}^{2}} \frac{1}{M} {\sum }^{} {μ}_{i} ( {κ}_{i} ) {F}_{zi} \qquad ( 4 )$$

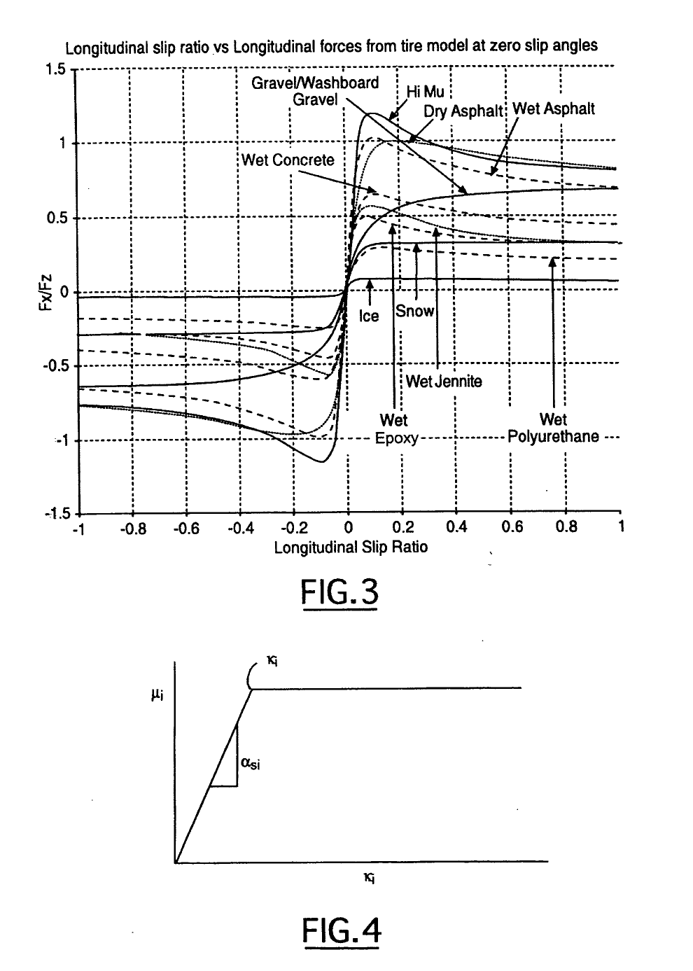

Referring now to FIG. 3, the friction coefficient curves for a number of road-tire interfaces are illustrated. As is evident, the peak of the friction coefficient curve varies significantly depending on the road condition. The slip value at the peak friction coefficient also varies between 0.1 to 0.2. It is clear that the friction coefficient relationship with slip adds nonlinearity to equation (4). Since all of the curves in FIG. 3 exhibit linear relationship with slip below the peak of the curve, the relationship between the coefficient of friction and the slip can be approximated with a piecewise linear function. This concept is illustrated in FIG. 4. The friction curves are approximated by a straight line with a slope of αₛᵢ and a slip threshold of kₜₕ. While the peak of these friction curves varies over a slip range, a slip threshold κₜₕ and initial slope αₛᵢ can be established for sub-optimal performance. Sub optimal refers to the inexact value of the threshold κₜₕ that varies between 0.1 and 0.2 as noted in FIG. 3 above. As noted below, some value may be chosen for approximation.

The piecewise linear friction coefficient-slip relationship can be described as follows.
μᵢ(κᵢ)=αₛᵢ*κᵢ if κᵢ≦κₜₕ
=αₛᵢ*κₜₕ if κᵢ≧κₜₕ (5)

Therefore, equation (4) can be rewritten as,

$${\dot{κ}}_{i} = \frac{R}{{I}_{wi}} \frac{1}{V} {T}_{bi} - \frac{{R}^{2}}{{I}_{wi}} \frac{1}{V} {α}_{si} {κ}_{i} {F}_{zi} - \frac{\dot{R} {ω}_{i}}{{V}^{2}} \frac{1}{M} {\sum }^{} {α}_{si} {κ}_{i} {F}_{zi} \qquad ( 6 )$$

The sliding surface may be defined as follows,
S=(κₜₕ−κᵢ) (7)

It is assumed here that the desired slip is the same as the slip threshold. With the above definition of the sliding surface, the sliding mode control law is given by,

$$\dot{S} = - ηSAT - ηSAT ( \frac{S}{ϕ} )$$

where

η=Convergence Factor; φ=Boundary Layer Thickness
Further simplifying,

$$\dot{{κ}_{th}} - \frac{R}{{I}_{wi}} \frac{1}{V} {T}_{bi} + \frac{{R}^{2}}{{I}_{wi}} \frac{1}{V} {α}_{si} {κ}_{i} {F}_{zi} + \frac{R {ω}_{i}}{{V}^{2}} \frac{1}{M} {\sum }^{} {α}_{si} {κ}_{i} {F}_{zi} = - ηSAT ( \frac{{κ}_{th} - {κ}_{i}}{ϕ} ) \qquad ( 8 )$$

Hence the control law is given by,

$${T}_{bi} = \frac{{VI}_{wi}}{R} {\dot{κ}}_{th} + R {α}_{si} {κ}_{i} {F}_{zi} + \frac{{I}_{wi}}{V} \frac{{ω}_{i}}{M} \sum {α}_{si} {κ}_{i} {F}_{zi} + η \frac{{I}_{wi}}{R} V * SAT ( \frac{{κ}_{th} - {κ}_{i}}{ϕ} ) \qquad ( 9 )$$

If κₜₕ is a constant, then the above control law becomes,

$${T}_{bi} = R {α}_{si} {κ}_{i} {F}_{zi} + \frac{{I}_{wi}}{V} \frac{{ω}_{i}}{M} {\sum }^{} {α}_{si} {κ}_{i} {F}_{zi} + η \frac{{I}_{wi}}{R} V \cdot SAT ( \frac{{κ}_{th} - {κ}_{i}}{θ} ) \qquad ( 10 )$$

Equation (10) is the proposed control law for the anti-lock braking system. As can be seen the brake torque (and the corresponding pressure) is dependent upon the normal force of the tire F_{zi} the tire slip and the value chosen for the peak slip angle.

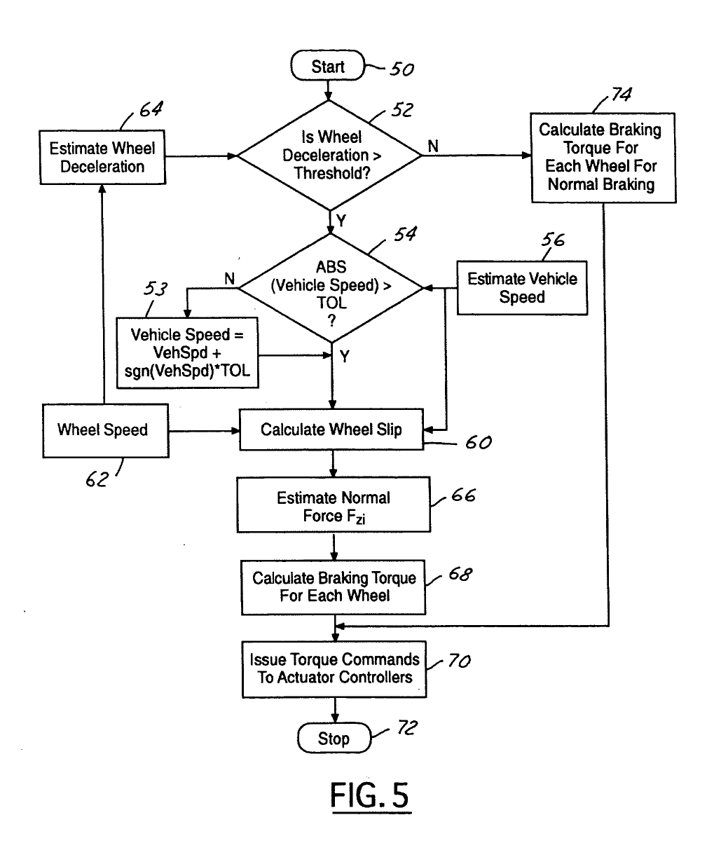

Referring now to FIG. 5, the proposed controller implementation is illustrated in the flow chart starting in step 50. Since equation (10) will provide ABS functionally based on a predefined slip threshold value, the braking performance may be compromised for a normal high friction coefficient road surface. Hence, in the controller implementation, an ABS mode detection is implemented based on the impending wheel lock-up. In step 52 the deceleration of the vehicle is compared to a predetermined threshold value. If the wheel deceleration is greater than a certain threshold value in step 52, the controller raises a flag and the ABS loop is then activated.

After step 52, step 54 is implemented which monitors the absolute value of the speed and compares it to a threshold TOL. Step 54 insures that the vehicle is above a predetermined limit TOL such as zero. That is, the threshold limit ensures that the vehicle is moving. Step 54 relies upon step 56, which because it is estimated, may not actually be zero and therefore some low threshold limit is set in step 54. If the vehicle is not above the threshold speed the vehicle speed is calculated in step 58 according to the formula therein. The formula is step 58 for determining vehicle speed is Vehicle Speed=VehSpd+sgn(VehSpd)*TOL. From step 58 the wheel speed is calculated in step 60. The wheel slip is calculated according to Equation 1 described above. The wheel slip calculation in block 60 also uses the rotational wheel speed from the wheel speed sensor in block 62. From the wheel speed sensor the wheel deceleration may be estimated in step 64, which in turn is used in step 52 described above.

After the wheel slip is determined in step 60, step 66 is estimated in which the normal force F_{zi} is estimated according to the formulas described above. Once the normal force estimate F_{zi} and the wheel slip are determined the modified braking torque for each wheel is determined in step 68 according to Equation 10 above. The modified brake torque is different than the brake torque corresponding to brake pedal travel. Based on the calculated brake torque, the braking actuators are commanded to control the brakes accordingly in step 70. The system ends in step 72.

Referring back to step 52, when the deceleration is not above the threshold step 74 is executed in which the brake torque applied for each wheel is the normal braking force associated with the amount of pressure placed upon the brake pedal and not a modified brake torque described in FIG. 10. After step 74, steps 70 and 72 are executed as described above. When step 74 is executed an unmodified brake torque is applied in step 68. That is the amount of brake torque directly corresponds to the input (travel) of the brake pedal.

While particular embodiments of the invention have been shown and described, numerous variations and alternate embodiments will occur to those skilled in the art. Accordingly, it is intended that the invention be limited only in terms of the appended claims.

1. A control system for an automotive vehicle having a wheel and wheel brake comprising:
a wheel speed sensor generating a rotational speed signal; and
a controller coupled to the wheel speed sensor, said controller determining a vehicle speed, calculating an actual wheel slip based upon the vehicle speed and the rotational speed, estimating a normal force on the wheel, calculating a modified brake torque signal in response to a saturation function of a threshold slip and the actual wheel slip, an approximated friction curve slope, and the normal force, and actuating the wheel brake in response to the modified brake torque signal.

2. A system as recited in claim 1 further comprising a vehicle speed sensor, said controller determining vehicle speed from the vehicle speed sensor.

3. A system as recited in claim 2 wherein the vehicle speed sensor comprises plurality of wheel speed sensors.

4. (canceled)

5. A system as recited in claim 1 wherein said controller measures a wheel deceleration from the wheel speed sensor; when the wheel deceleration is above a threshold applying the modified torque.

6. A system as recited in claim 5 wherein said controller applies an unmodified torque when the wheel deceleration is below a threshold.

7. A method of controlling a vehicle having a wheel and wheel brake comprising:
measuring rotational speed of a wheel;
determining a vehicle speed;
calculating an actual wheel slip based upon the vehicle speed and the rotational speed;
estimating a normal force on the wheel;
calculating a modified brake torque signal in response to a saturation function of a threshold slip and the actual wheel slip, an approximated friction curve slope, and the normal force; and
actuating the wheel brake in response to the modified brake torque signal.

8. (canceled)

9. A method as recited in claim 7 further comprising measuring a wheel deceleration; when the wheel deceleration is above a threshold applying a modified brake torque.

10. A method as recited in claim 9 further comprising applying an unmodified torque when the wheel deceleration is below a threshold.

11. A method as recited in claim 7 further comprising when the vehicle speed is above a speed threshold, performing calculating wheel slip based upon the vehicle speed and the rotational speed, estimating a normal force on the wheel, calculating a modified brake torque signal in response to the wheel slip and the normal force, and actuating the wheel brake in response to the modified brake torque signal when a wheel deceleration is below a threshold.

12. A method as recited in claim 7 wherein calculating an actual wheel slip comprises calculating a normalized wheel slip value.

13. A method as recited in claim 7 wherein determining a vehicle speed comprises determining a vehicle speed in response to the wheel speed.

14. A method of controlling braking of an automotive vehicle having a plurality of wheels and brakes comprising:
measuring rotational speed of the plurality of wheels;
determining a vehicle speed;
calculating a respective actual wheel slip for the plurality of wheels based upon the vehicle speed and a respective rotational speed;
estimating a normal force on the plurality of wheels;
calculating a respective modified brake torque signal in response to a saturation function of a threshold slip and the actual wheel slip, an approximated friction curve slope, and the normal force for each of the plurality of wheels; and
actuating a respective brake in response to the respective modified brake torque signal.

15. (canceled)

16. A method as recited in claim 14 further comprising measuring a wheel deceleration; when the wheel deceleration is above a threshold applying the respective modified torque, and applying an unmodified torque when a wheel deceleration is below a threshold.

17. A method as recited in claim 14 wherein calculating a respective wheel slip comprises calculating a respective normalized wheel slip value.

18. A method as recited in claim 14 wherein determining a vehicle speed comprises determining a vehicle speed in response to the wheel speed.

19. A system as recited in claim 1 wherein the controller calculates a modified brake torque signal in response to a saturation function of a difference of a threshold slip and the actual wheel slip, an approximated friction curve slope, and the normal force.

20. A system as recited in claim 1 wherein the controller calculates a modified brake torque signal in response to a saturation function of a difference of a threshold slip, the actual wheel slip and a boundary later thickness, an approximated friction curve slope, and the normal force.

21. A system as recited in claim 1 wherein the controller calculates a modified brake torque signal in response to a saturation function of a difference of a threshold slip, the actual wheel slip and a boundary later thickness, a convergence factor, an approximated friction curve slope, and the normal force.

22. A method as recited in claim 7 wherein calculating a modified brake torque signal in response to a saturation function of a threshold slip and the actual wheel slip, an approximated friction curve slope, and the normal force comprises calculating a modified brake torque signal in response to a saturation function of a difference of a threshold slip and the actual wheel slip, an approximated friction curve slope, and the normal force.

23. A method as recited in claim 7 wherein calculating a modified brake torque signal in response to a saturation function of a threshold slip and the actual wheel slip, an approximated friction curve slope, and the normal force comprises calculating a modified brake torque signal in response to a saturation function of a difference of a threshold slip, the actual wheel slip and a boundary later thickness, an approximated friction curve slope, and the normal force.

24. A method as recited in claim 7 wherein calculating a modified brake torque signal in response to a saturation function of a threshold slip and the actual wheel slip, an approximated friction curve slope, and the normal force comprises calculating a modified brake torque signal in response to a saturation function of a difference of a threshold slip, the actual wheel slip and a boundary later thickness, a convergence factor, an approximated friction curve slope, and the normal force.

25. A method as recited in claim 14 wherein calculating a respective modified brake torque signal in response to a saturation function of a threshold slip and the actual wheel slips, an approximated friction curve slope, and the normal force for each of the plurality of wheel comprises calculating a respective modified brake torque signal in response to a saturation function of a difference of a threshold slip and the actual wheel slips, an approximated friction curve slope, and the normal force for each of the plurality of wheel.

26. A method as recited in claim 14 wherein calculating a respective modified brake torque signal in response to a saturation function of a threshold slip and the actual wheel slips, an approximated friction curve slope, and the normal force for each of the plurality of wheel comprises calculating a respective modified brake torque signal in response to a saturation function of a difference of a threshold slip, the actual wheel slips and a boundary later thickness, an approximated friction curve slope, and the normal force for each of the plurality of wheel.

27. A method as recited in claim 14 wherein calculating a respective modified brake torque signal in response to a saturation function of a threshold slip and the actual wheel slips, an approximated friction curve slope, and the normal force for each of the plurality of wheel comprises calculating a respective modified brake torque signal in response to a saturation function of a difference of a threshold slip, the actual wheel slips and a boundary later thickness, a convergence factor, an approximated friction curve slope, and the normal force for each of the plurality of wheel.
